(19) United States
(12) Patent Application Publication
(10) Pub. No.: US 2020/0132242 A1
(43) Pub. Date: Apr. 30, 2020

(54) SELF DRIVEN PIG

(71) Applicant: Innerpipe Robocam Scan, LLC, Pasadena, TX (US)

(72) Inventors: John Daniel Yamokoski, Houston, TX (US); Alexander Craig Kundrot, Webster, TX (US); Brian James Wightman, Houston, TX (US); Reginald Bruce Berka, Houston, TX (US); Nicolaus Adam Radford, Houston, TX (US); Rodney Matthew Ondler, Houston, TX (US)

(21) Appl. No.: 16/427,254

(22) Filed: May 30, 2019

(30) Foreign Application Priority Data
Oct. 30, 2018 (CA) 3022582

(51) Int. Cl. F16L 55/32; G01D 11/24

(52) U.S. Cl. CPC F16L 55/32; F16L 2101/30; G01D 11/245

(57) ABSTRACT

A self driven pig may have a drive using slanted wheels on an element rotated axially relative to a reference element to drive the pig along a pipe, and may have a sensor carrier with a housing holding the sensors which rotates axially to provide better sensor coverage of the walls of the pipe.

### PRIORITY CLAIM

This application claims priority from Canada Patent Application No. 3,022,582 filed Oct. 30, 2018, which application is incorporated herein by reference in its entirety.

### FIELD OF THE INVENTION

Pipeline pigs.

### BACKGROUND OF THE INVENTION

Pipeline pigs comprising multiple modules connected together are known, but improved drives and sensor carrier elements are desired.

### SUMMARY OF THE INVENTION

There is provided a drive for a pig, the drive having a rotation element having drive wheels biased outwards and positioned in a slanted orientation to drive the rotation element along a pipe when the rotation element is rotated within the pipe, a reference element having reference wheels biased outwards and oriented in a different orientation than the slanted orientation, and a motor for rotating the rotation element relative to the reference element. The different orientation may be a straight orientation.

There is also provided a sensor carrier for a pig, the sensor carrier having a rotatable housing connected to a drive element for rotating the rotatable housing around an axis defined by the rotatable housing and the drive element, the axis arranged to be generally aligned with a bore of a pipe when the pig is positioned within the pipe, and one or more sensors disposed on the rotatable housing.

In various embodiments, there may be included any one or more of the following features: there may also be one or more contact elements disposed on the rotatable housing for contacting walls of the pipe and spacing the rotatable housing from the walls of the pipe when the pig is positioned within the pipe; there may also be one or more variable height elements disposed on the rotatable housing, each sensor disposed on a corresponding variable height element; the contact elements may be disposed on the variable height elements; and the contact elements may comprise rollers and roller supports, the roller supports being rotatably connected to the rotatable housing.

These and other aspects of the device and method are set out in the claims.

### BRIEF DESCRIPTION OF THE DRAWINGS

Embodiments will now be described with reference to the figures, in which like reference characters denote like elements, by way of example, and in which:

FIG. 1 is a side view of a self-driven pig;

FIG. 2 is a section view of the pig of FIG. 1;

FIG. 3 is an isometric view of a drive for the pig of FIG. 1;

FIG. 4 is an end view of the drive of FIG. 3;

FIG. 5 is a section view of the drive of FIG. 4;

FIG. 6 is an isometric view of a sensor unit for the pig of FIG. 1;

FIG. 7 is a side view of the sensor unit of FIG. 6; and

FIG. 8 is a section view of the sensor unit of FIG. 7.

### DETAILED DESCRIPTION OF THE PREFERRED EMBODIMENT

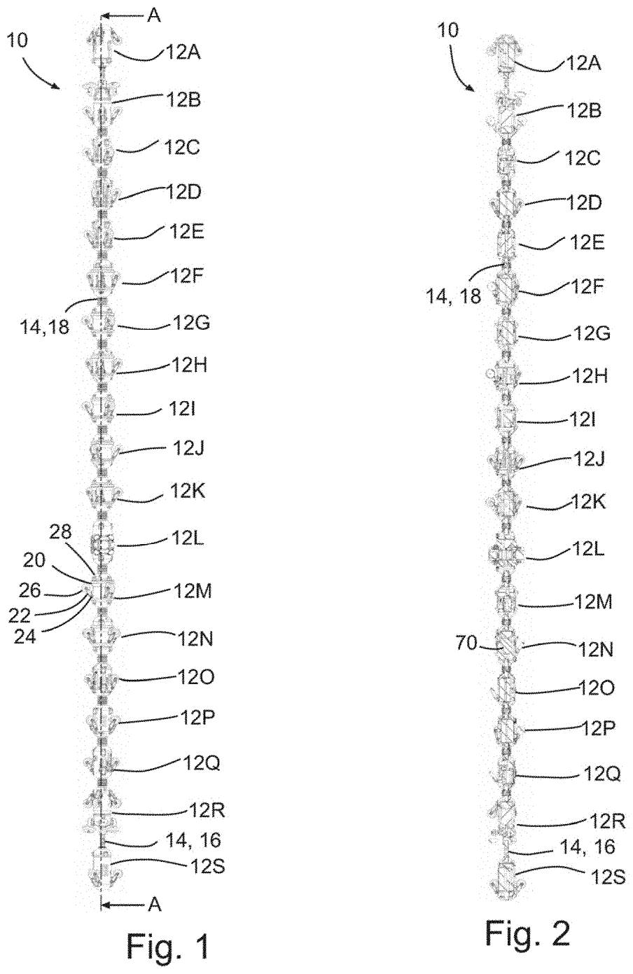

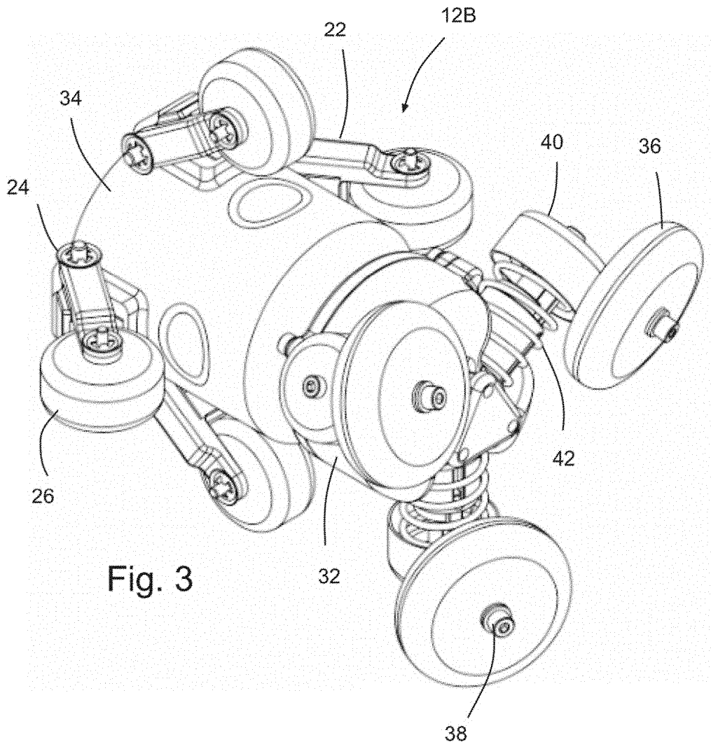

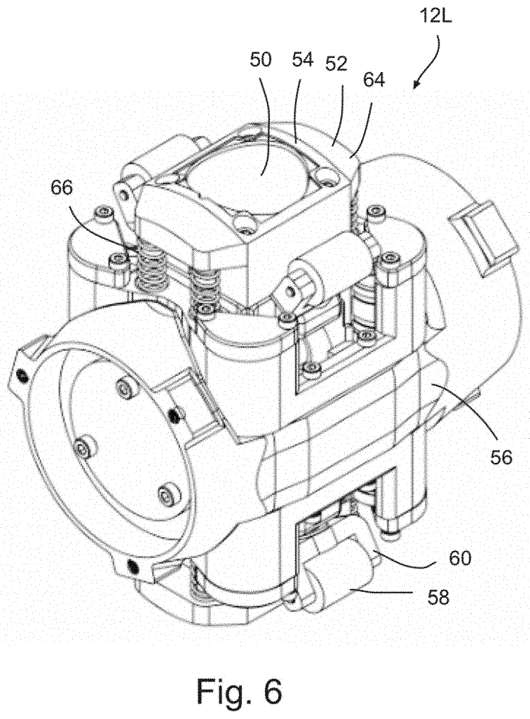

As shown in FIG. 1 and FIG. 2, a self-driven pig 10 may be formed of multiple modules, here labeled 12A-12S, linked together by connections 14. The self-driven pig is intended to be deployed within a pipe (not shown) to inspect the pipe. The self-driven pig may communicate with operators using any suitable method, for example, wi-fi signals.sent between an antenna (not shown) in the pig and another antenna at an open end of the pipe. Various numbers or combinations of modules may be used. In the particular embodiment shown, the modules are, from top to bottom: a trailing camera module 12A, a trailing drive module 12B, a trailing controller module 12C, a battery module 12D, a second battery module 12E, a sensor battery module 12F, a second sensor battery module 12G, a sensor electronics module 12H, a second sensor electronics module 12I, a third sensor electronics module 12J, a CPU and data acquisition module 12K, a sensor module 12L, a CPU module 12M, a rotation motor module 12N, a leading battery module 12O, a second leading battery module 12P, a leading controller module 12Q, a leading drive module 12R, and a leading camera module 12S. “Leading” and “trailing” refer to positon relative to a usual direction of motion; the pig may be driven in either direction. The connections 14 between modules may comprise a universal joint 16 and electronic wiring (not shown) and may be enclosed by a flexible enclosure such as ribbed tubing 18. In order to allow rotation of modules relative to one another, the embodiment shown has modules each comprising a housing 20 and end caps 28, at least one of the end elements connected to any given connector 14 being rotatable with respect to the housing 20 of its module. Ring connectors (not shown) allow electronic connections through the rotatable connections between housing 20 and end caps 28. In the embodiment shown, each module has a housing 20 and contact elements for contacting the pipe walls, the contact elements disposed on variable height elements extending from the housing 20 for spacing the housing 20 from the pipe walls. Here “variable height” refers to variable distance of extension from the housing, or variable extension away from a central axis defined by the pig module. The variable height elements may be actively adjustable in height or passively change height in response to forces imposed on them, for example, they may be biased towards the pipe walls by springs. In the embodiment shown, most of the variable height elements are arms 22 disposed on hinges 24. The arms 22 are biased outwards by springs (not shown). The contact elements on these arms are wheels 26 which are in this embodiment positioned in a straight orientation, that is, in an orientation such that each rotates about a respective axis perpendicular to the axis of the pig module. This alignment leads these modules not to rotate as the pig moves along the pipe. Sensor module 12L is shown in more detail in FIGS. 6-8, and a drive module 12B is shown in more detail in FIGS. 3-5. FIG. 2 shows a section view of the pig of FIG. 1, as seen along the section line A shown in FIG. 1. In the embodiment shown, it is estimated that the first 5 modules mass in total 1.35 kg, as do the last 5 modules, and the 9 modules in the middle mass in total 3.89 kg.

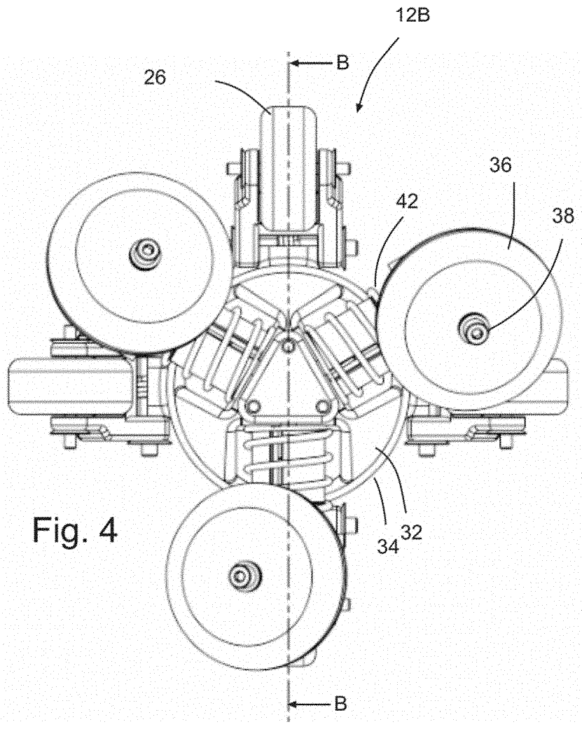

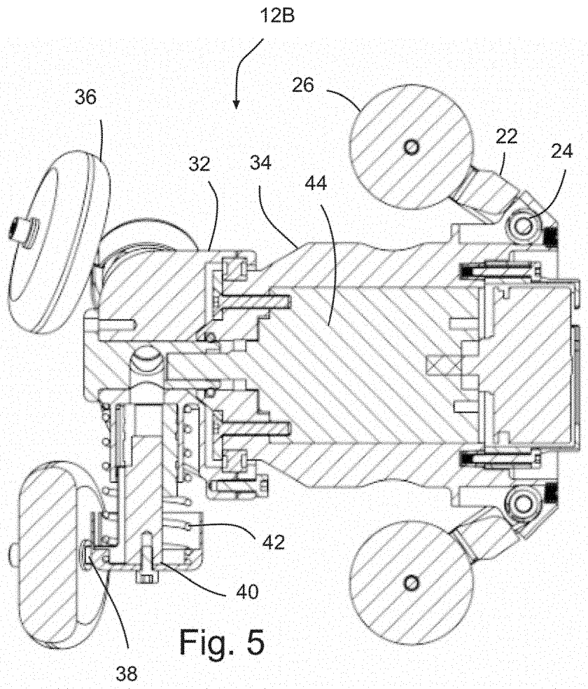

FIG. 3 shows a drive module 12B for the pig of FIGS. 1-2. The drive module 12B comprises a rotation element 32 and a reference element 34. In the embodiment shown the reference element 34 has straight oriented wheels 26 on arms 22 rotatably mounted on hinges 24 and biased outwards towards the pipe walls. The rotation element 32 has wheels 36 positioned in a slanted orientation, that is, oriented so that each rotates about an axis not perpendicular to axis defined by the pig module. The slanted orientation is arranged so that when the rotation element is rotated within the pipe, it is driven along the pipe by the slant of the wheels. In this embodiment, the slanted wheels are positioned on hubs 38 mounted on adjustable height elements 40. The adjustable height elements define axes of rotation and are rotatable about the axes. Springs 42 bias hubs 38 rotationally about the axes to bias the wheels 36 to the pipe walls. FIG. 4 shows an end view of the drive module 12B. FIG. 5 shows a section view of the drive module 12B, as seen when cut along section line B shown in FIG. 4. A motor 44 drives the rotation element rotationally relative to the reference element. The motor is shown within the reference element 34 but could also be within the rotation element 32. Although in this embodiment, the reference element and rotation element are parts of a single module, the rotation element and reference element of a drive for a pig could also in principle be parts of different modules, for example, a module could comprise a rotational element with a motor within the rotational element for driving the rotational element with respect to an adjacent module; the adjacent module would then be the reference element. The reference element has wheels with a different orientation than the rotation element, so that rotation of the rotation element relative to the reference element causes the pig to move within the pipe. While in this embodiment the reference element has straight wheels, the reference element could also have slanted wheels, with a different slant than the wheels of the rotation element (for example a reverse slant).

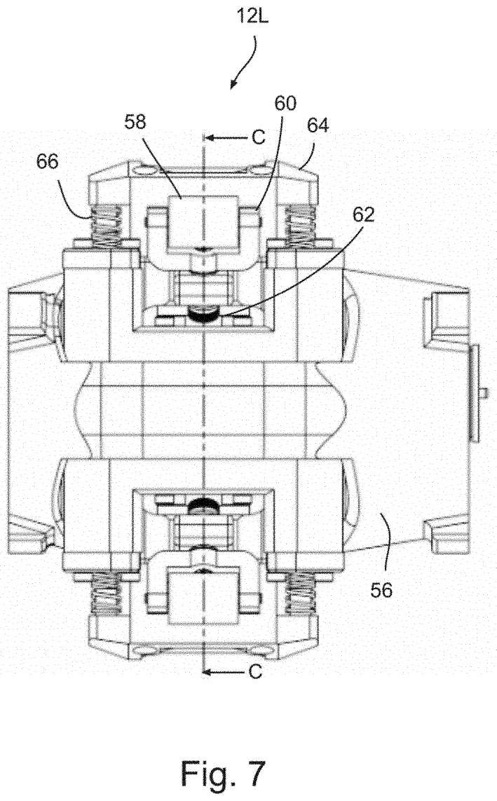

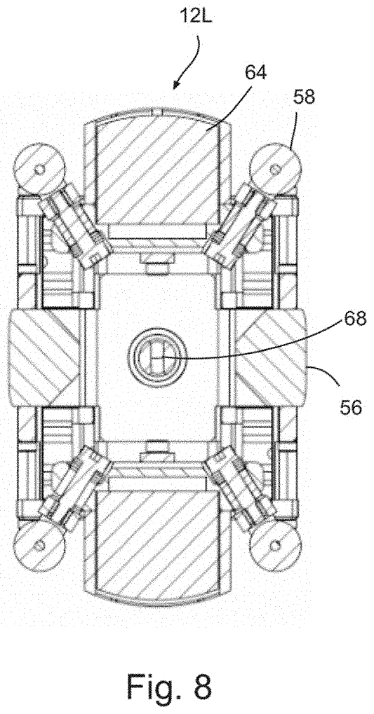

FIGS. 6-8 show a sensor module 12L mounting sensors 50. The sensors may be, for example, Electromagnetic Acoustic Transducer (EMAT) sensors. The sensors may be mounted within a sensor mounting area 52 defining a recess 54 in which sensor 50 is mounted for protection against accidental contact with the pipe walls or with deposits on the pipe walls. The sensors 50 are connected to a rotatable housing 56 that can rotate within the pipe in order to provide full sensor coverage of the pipe surface. The rotatable housing 56 may rotate with respect to a non-rotating portion of the module or the module as a whole may rotate. Rollers 58 act as contact elements in this embodiment for spacing the rotatable housing from the pipe walls. The rollers 58 may be supported by rotatable support elements 60 so that the rollers may change orientation to match different combinations of rotation within and movement along the pipe. Sockets 62, shown in FIG. 7, support the rotatable support elements 56 for rotation. Other contact elements may be used, for example, balls that are omnidirectionally rotatable within balls seats. The sensors 50 and contact elements may be mounted on variable height elements 64. By mounting both the contact elements and sensors on the variable height elements 64, the sensors may be kept an intended distance from the pipe walls (for example 1 mm) when the contact elements are contacting the pipe walls. FIG. 8 shows a cross section of the sensor module 12L as seen on at section line C shown in FIG. 7. In the embodiment shown, the variable height elements 64 for the sensors 50 and rollers 58 are sliding elements biased outwards by springs 66 and adjustable using a twisted cord (not shown) that is held taut by the biasing action of the springs 66. The twisted cord may be adjusted in tension using a spool 68 shown in FIG. 8. The spool may in turn be driven by a motor (not shown), in this embodiment also within the sensor module 28. The rotatable housing may be driven by a motor 70 (not shown in FIGS. 6-8, but shown in FIG. 2) within the sensor module or from another module, for example an adjacent module. In the embodiment shown, the sensor module is driven by a motor 70 in a module two modules over from the sensor module, with the mechanical rotation generated by the motor connected to the rotatable housing via a mechanical coupling (not shown) such as a flexible shaft. Other means that could be used to connect the mechanical rotation of the motor 70 to the rotatable housing include making any intermediate modules between the rotatable housing 56 and the motor 70 also rotatable, and the end caps 28 of the motor module and any intermediate modules not rotatable with respect to housing 20, such that the intermediate modules and the joints connecting them convey the rotational motion to the rotatable housing.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A drive for a pig, the drive comprising:
a rotation element having drive wheels positioned in a slanted orientation to drive the rotation element along a pipe when the rotation element is rotated within the pipe;
a reference element having reference wheels biased outwards and oriented in a different orientation than the slanted orientation; and
a motor for rotating the rotation element relative to the reference element.

2. The drive of claim 1 in which the different orientation is a straight orientation.

3. A sensor carrier for a pig, the sensor carrier comprising:
a rotatable housing connected to a drive element for rotating the rotatable housing around an axis defined by the rotatable housing and the drive element, the axis arranged to be generally aligned with a bore of a pipe when the pig is positioned within the pipe; and
one or more sensors disposed on the rotatable housing.

4. The sensor carrier of claim 3 further comprising one or more contact elements disposed on the rotatable housing for contacting walls of the pipe and spacing the rotatable housing from the walls of the pipe when the pig is positioned within the pipe.

5. The sensor carrier of claim 4 further comprising one or more variable height elements disposed on the rotatable housing, each sensor disposed on a corresponding variable height element.

6. The sensor carrier of claim 5 in which the contact elements are disposed on the variable height elements.

7. The sensor carrier of claim 4 in which the contact elements comprise rollers and roller supports, the roller supports being rotatably connected to the rotatable housing.

8. The sensor carrier of claim 5 in which the contact elements comprise rollers and roller supports, the roller supports being rotatably connected to the rotatable housing.

9. The sensor carrier of claim 6 in which the contact elements comprise rollers and roller supports, the roller supports being rotatably connected to the rotatable housing.
